(19) United States
(12) Patent Application Publication
(10) Pub. No.: US 2001/0005436 A1
(43) Pub. Date: Jun. 28, 2001

(54) Arrangement in an air bearing

(76) Inventors: Hans Sjostrom, Goteborg (SE); Borje Andersson, Molndal (SE)

Correspondence Address: BURNS DOANE SWECKER & MATHIS L L P, POST OFFICE BOX 1404, ALEXANDRIA, VA, 22313-1404, US

(21) Appl. No.: 09/736,322

(22) Filed: Dec. 15, 2000

(30) Foreign Application Priority Data
Dec. 17, 1999 (SE) 9904639-3

(51) Int. Cl. F16C 32/06

(52) U.S. Cl. 384/123

(57) ABSTRACT

An air bearing of the type having a first component with a first surface and a second component with a first surface, wherein the surfaces are movable relative to each other with a small space provided between the first surfaces. At least one of the surfaces facing each other being provided with a groove pattern producing during mutual movement of the components a pumping effect in a gas medium provided between the groove provided surface of the one component and the counter-surface of the other component for creating a thin medium film preventing physical contact of the surfaces during mutual motion. The counter-surface is provided with a thin coating for preventing wear at contact between the surfaces.

This application is based on and claims priority under 35 U.S.C. § 119 with respect to Swedish Application No. 9904639-3 filed on Dec. 17, 2000, the entire content of which is incorporated herein by reference.

### FIELD OF THE INVENTION

The present invention generally relates to bearings. More particularly, the present invention pertains to aerodynamic bearings or air bearings of the type having two members with surfaces facing each other and being in mutually rotating relation, with one of the surfaces being provided with a surface structure designed to create an air pressure between the two mutually rotating surfaces thereby forming a thin lubricant film of air or other gas inhibiting or preventing the surfaces from physically contacting when subjected to relative motion.

### BACKGROUND OF THE INVENTION

Aerodynamic or air bearings that include two members with facing surfaces designed so that one of the surfaces possesses a surface structure (structured surface or groove-provided bearing surface) which creates an air pressure forming a thin lubricant film of air or other gas are substantially supported only on the air film. During start and stop sequences, the speed of the rotating bearing member may not be sufficient to prevent the bearing members from physically contacting each other during the first part of the start up procedure and during the speed reduction experienced when the rotation of the bearing is coming to a stop. This means that there will be high friction and consequently high wear in the bearing member surface facing the structured or groove-provided bearing surface before the rotating bearing member has reached a speed causing sufficient pumping effect or when the speed has dropped to such an extent that the “upper” bearing member is “landing” on the “lower” bearing member.

The grooved or structured bearing surface is generally produced by making the desired groove pattern directly in the base material by way of cutting machining or by a chemical etching technique. The techniques used for producing the required shallow and fine groove patterns in the surface in question have made it necessary to use materials which are relatively easy to cut, either with mechanical cutting tools or with chemical etching procedures. The opposing counter surface is made as a smooth surface of the same material as the structured bearing surface. The counter surface is thus rapidly worn-out because of the metallic contact between the slowly rotating bearing members at the inevitable start and stop sequences.

A need thus exists for an air bearing or aerodynamic bearing that is not as susceptible to the problems discussed above.

A need also exists for an air bearing or aerodynamic bearing in which rapid wearing of the counter surface of the bearing member opposing the structured or grooved bearing member is reduced.

### SUMMARY OF THE INVENTION

In accordance with the present invention, an air bearing includes a first component with a first surface and a second component with a first surface, with the first surfaces of the first and second components facing one another and being relatively movable with respect to one another with a space provided between the first surfaces of the first and second components. The first surface of at least one of the components form a counter-surface and the first surface of the other component has a groove pattern which produces during mutual movement of the components a pumping effect in a gas medium provided between the surface having the groove pattern and the counter-surface for creating a thin medium film preventing the first surfaces from physical contact during mutual motion. The counter-surface is provided with a coating for preventing wear at contact between the first surfaces.

According to another aspect of the invention, an air bearing includes a first bearing washer having a grooved surface facing a counter-surface of a second bearing washer, with at least one of the bearing washers being rotatable relative to the other bearing washer with a space provided between the grooved surface and the counter-surface to produce during rotation a pumping effect in a gas medium provided between the grooved surface and the counter-surface to create a medium film inhibiting the grooved surface and the counter-surface from physical contact. The counter-surface is provided with a coating having a coefficient of friction between about 0.1μ and about 0.2μ for inhibiting wear at contact between the counter-surface and the grooved surface.

According to another aspect of the present invention, an air bearing includes a lower bearing washer having a grooved surface facing a counter-surface of an upper bearing washer. The grooved surface is formed by a plurality of grooves. At least one of the lower and/or upper bearing washers is rotatable relative to the other bearing washer with a space provided between the grooved surface and the counter-surface to produce during rotation a pumping effect in a gas medium provided between the grooved surface and the counter-surface to create a medium film inhibiting physical contact between the grooved surface and the counter-surface. The counter-surface is provided with a coating having a Vickers hardness above 1000 HV and a coefficient of friction less than about 0.2μ for inhibiting wear at contact between the counter-surface and the grooved surface.

### BRIEF DESCRIPTION OF THE DRAWING FIGURES

The foregoing and additional features and characteristics of the present invention will become more apparent from the following detailed description considered with reference to the accompanying drawing figures in which like reference numerals designate like elements and wherein:

FIG. 1 is a side view, partly in section, showing the upper and lower bearing washers of an air bearing in accordance with the present invention;

FIG. 2 is a top plan view of the groove provided lower bearing washer of the bearing shown n FIG. 1; and

FIG. 3 is a plan view showing the upper bearing washer of FIG. 1 as seen from the side facing the groove provided side of the lower bearing washer.

### DETAILED DESCRIPTION OF THE INVENTION

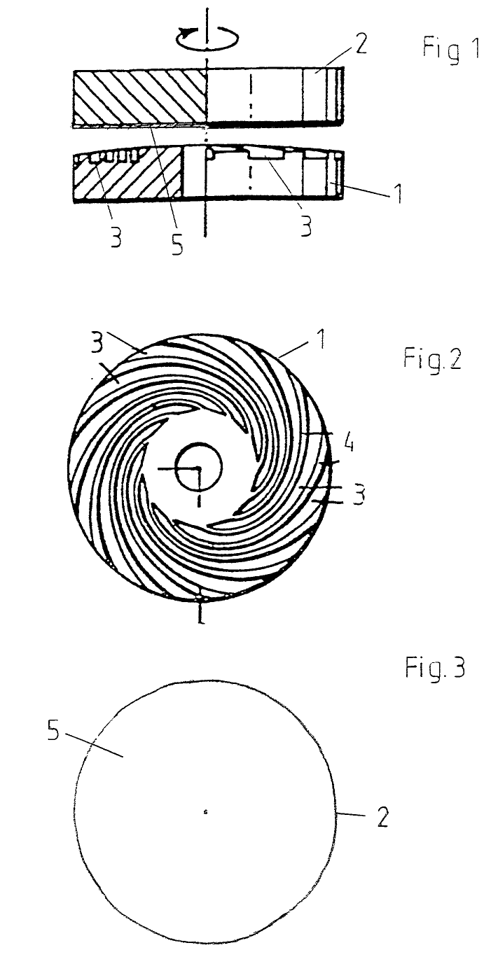

Features associated with the air bearing or aerodynamic bearing of the present invention are illustrated in FIG. 1. The illustrated and described air bearing is merely shown as one version embodying the present invention, it being understood that the invention is equally applicable to other types of air bearings.

The illustrated air bearing includes a stationary lower bearing washer 1 and an upper bearing washer 2. The upper bearing washer 2 is rotatable in relation to the lower washer 1. In the illustrated embodiment, the upper bearing washer 2 is designed as a cylindrical washer with planar, smooth surfaces. The side of the stationary, lower bearing washer 1 turned towards or facing towards the upper bearing washer 2 is slightly crowned and has a number of substantially or generally helical grooves 3. These grooves 3 are cut into the material of the washer by any appropriate mechanical machining method or by chemical etching. The top surface of the lower bearing washer 1 thus includes the grooves 3 and remaining material portions 4 positioned between adjacent grooves 3 and spacing apart the groves 3.

The pattern of the grooves 3 formed in the surface of the lower bearing washer 1 is better seen in FIG. 2, which is a top plan view from above the lower bearing washer 1. It is important that these recessed grooves 3 and the remaining material portions 4 are carefully made, with the grooves 3 having a continuously changing width in the helical direction to give a correct pumping effect for creating a thin film of air or liquid (at a hydrodynamic bearing) when the two bearing washers rotate relative to each other. The grooves 3 continuously increase in width from the radially inner portion of the lower bearing washer 1 to the radially outer portion of the lower bearing washer 1. This means that the production of the groove pattern is a relatively meticulous task and for this reason it is also common that the base material of the washer is chosen from a group of materials which is comparatively easy to work. The upper bearing washer 2 (i.e., the washer having a smooth, non-structured or non-grooved surface) is commonly made of the same easy-to-work material as the groove provided washer 1.

The above-mentioned physical contact between the surfaces of the two bearing washers facing each other, which is experienced when the bearing is beginning to rotate and also when the mutual rotation of the bearing washers are coming to a stop, will tend to cause rapid wear on both surfaces during the start and stop sequences for the bearing when the relative rotational speed is insufficient for creating a supporting film.

In accordance with the present invention, the counter-surface of the bearing, that is the bearing surface opposed to the groove provided bearing surface on the lower bearing washer 1, is provided with a thin coating layer 5 as seen in FIG. 1. The thin coating layer 5 is a hard and wear-resistant material which is deposited upon the base material of the bearing washer 2.

Different materials can be used for this coating 5, but the material is preferably selected to have properties such as relatively high hardness, typically with a Vickers hardness above 1000 HV, a relatively low coefficient of friction μ, typically between about 0.1 and about 0.2, good wear resistance, good resistance against oxidation and fretting corrosion, and also good thermal stability.

Such a material can preferably be a metal mixed diamond like carbon (Me-DLC), and can preferably be deposited on the base material by an appropriate depositing method, including physical vapour deposition, i.e. vaporisation of the material in a vacuum chamber whereupon the vapour is caused to condense on the surface of the base material. The thickness of the coating can be from about 1 μm to about a few μm.

The coating surface 5 shown in cross section in FIG. 1 and in plan view in FIG. 3 not only results in a very much lower wear of the counter-surface, but is also advantageous from the standpoint that due to the low friction coefficient, the structured or grooved bearing surface will be less subjected to wear. The coating is preferably a material having a lower coefficient of friction, and a higher hardness and/or resistance to wear than the base material of the component 2.

The embodiment of the air bearing described above and illustrated in the drawing figures is an axial air bearing. However, it is to be understood that the invention is not limited to such a bearing in that the counter-surfaces or “landing surfaces” on all types of air bearings can be coated in a similar manner. That is, the present invention can be applied to radial bearings, taper bearings and so on.

It is also to be understood that the illustrated clearance between the upper washer 2 and the lower washer 1 has been exaggerated in size for the sake of clarity and facilitating an understanding of the present invention.

Although the invention has been described in connection with an axial bearing with a helical groove pattern in the stationary bearing component, it is envisioned that the groove pattern can have other forms. Also, the landing surface can be provided in the stationary bearing component instead of in the rotating member as illustrated.

The principles, preferred embodiments and modes of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An air bearing comprising a lower bearing washer having a grooved surface facing a counter-surface of an upper bearing washer, the grooved surface being formed by a plurality of grooves, at least one of the lower and upper bearing washers being rotatable relative to the other bearing washer with a space provided between the grooved surface and the counter-surface to produce during rotation a pumping effect in a gas medium provided between the grooved surface and the counter-surface to create a medium film inhibiting physical contact between the grooved surface and the counter-surface, the counter-surface being provided with a coating having a Vickers hardness above 1000 HV and a coefficient of friction less than about 0.2μ for inhibiting wear at contact between the counter-surface and the grooved surface.

2. The air bearing according to claim 1, wherein the coating is a material having a lower coefficient of friction, and a higher hardness than the material forming the upper bearing washer.

3. The air bearing according to claim 2, wherein the coating is metal mixed diamond like carbon (Me-DLC).

4. The air bearing according to claim 1, wherein the coating is metal mixed diamond like carbon (Me-DLC).

5. The air bearing according to claim 1, wherein the plurality of grooves are helically arranged grooves having an increasing width.

6. An air bearing comprising a first bearing washer having a grooved surface facing a counter-surface of a second bearing washer, at least one of the first and second bearing washers being rotatable relative to the other bearing washer with a space provided between the grooved surface and the counter-surface to produce during rotation a pumping effect in a gas medium provided between the grooved surface and the counter-surface to create a medium film inhibiting the grooved surface and the counter-surface from physical contact, the counter-surface being provided with a coating having a coefficient of friction between about 0.1μ and about 0.2μ for inhibiting wear at contact between the counter-surface and the grooved surface.

7. The air bearing according to claim 6, wherein the coating is a material having a lower coefficient of friction, and a higher hardness and/or resistance to wear than the material forming the second bearing washer.

8. The air bearing according to claim 7, wherein the coating is metal mixed diamond like carbon (Me-DLC).

9. The air bearing according to claim 6, wherein the coating is metal mixed diamond like carbon (Me-DLC).

10. The air bearing according to claim 6, wherein the grooved surface of the first bearing washer includes helically arranged grooves.

11. The air bearing according to claim 10, wherein the helically arranged grooves possess a width that increases in a radially outward direction of the first bearing washer.

12. An air bearing comprising a first component with a first surface and a second component with a first surface, the first surfaces of the first and second components facing one another and being relatively movable with respect to one another with a space provided between the first surfaces of the first and second components, the first surface of at least one of the components forming a counter-surface and the first surface of the other component having a groove pattern which produces during mutual movement of the components a pumping effect in a gas medium provided between the surface having the groove pattern and the counter-surface for creating a thin medium film preventing the first surfaces from physical contact during mutual motion, the counter-surface being provided with a coating for preventing wear at contact between the first surfaces.

13. The air bearing according to claim 12, wherein the coating is applied on the surface by a depositing method.

14. The air bearing according to claim 13, wherein the coating is a material having at least one of a lower coefficient of friction, a higher hardness and a higher resistance to wear than the material forming the component.

15. The air bearing according to claim 14, wherein the coating is metal mixed diamond like carbon (Me-DLC).

16. The air bearing according to claim 12, wherein the coating is a material having at least one of a lower coefficient of friction, a higher hardness and a higher resistance to wear than the material forming the component.

17. The air bearing according to claim 12, wherein the coating is metal mixed diamond like carbon (Me-DLC).

18. The air bearing according to claim 12, wherein the groove pattern includes helically arranged grooves.
